(19) United States
(12) Patent Application Publication
(10) Pub. No.: US 2008/0084609 A1
(43) Pub. Date: Apr. 10, 2008

(54) Diffuser plate having multi-aspheric structure

(75) Inventor: Chao-Ying Lin, Jhongli Industrial Park (TW)

Correspondence Address: TROXELL LAW OFFICE PLLC, Suite 1404, 5205 Leesburg Pike, Falls Church, VA, 22041, US

(73) Assignee: ENTIRE TECHNOLOGY CO., LTD.

(21) Appl. No.: 11/544,030

(22) Filed: Oct. 6, 2006

(51) Int. Cl. G02B 5/02

(52) U.S. Cl. 359/599; 359/708

(57) ABSTRACT

A diffuser plate having a multi-aspheric structure comprises a plate and at least one aspheric microstructure. The plate is made of a transparent polymer. The plate is doped with a UV absorbent and several diffusion particles. The aspheric microstructure is formed on at least one surface of the plate. By the use of the aforesaid structure, the present invention can improve the conventional problems and provide the advantages including high light transmission rate, raised diffusion capability, improved brightness, and uniform light beams.

### FIELD OF THE INVENTION

The present invention relates to a diffuser plate having a multi-aspheric structure, and more particularly to a diffuser plate that utilizes a plate and at least one aspheric microstructure to provide many advantages including high light transmission rate, raised diffusion capability, improved brightness, and uniform light beams.

### BACKGROUND OF THE INVENTION

Generally speaking, a general diffuser plate is applied to a LCD monitor so as to allow a cold cathode fluorescent lamp (CCFL) of the LCD monitor to diffuse the light beams uniformly, thereby obtaining a uniform area light source. Referring to FIG. 1 and FIG. 2, a diffuser plate is treated with two methods. In the first method, a diffuser plate 1′ is doped with diffusion particles 11′ so as to reflect, refract or scatter the light beams by the diffusion particles 11′. In the second method, a diffuser plate 1′ is doped with diffusion particles 11′ and a refraction structure 2′ is formed on the top of the diffuser plate 1′ so as to diffuse the light beams more uniformly. The second kind of diffuser plate provides better diffusion effect and is thus widely applied to the photonics industries.

Referring to FIG. 3, a curve diagram is disclosed, wherein the curve line A indicates that no diffuser plate is utilized, and the curve line B indicates that the above-mentioned two methods are utilized. This diagram is related to the distribution of brightness, which is utilized usually for estimating the relationship between the relative brightness and the position of the backlight module and for estimating the brightness distribution of the backlight module along a longitudinal cross-section perpendicular to the lamp. The uniformity and brightness performance of the backlight module can be shown in this diagram. In the FIG. 3, the horizontal coordinate is the absolute coordinate of the backlight module. The vertical coordinate is the relative brightness after normalization. After comparison, the brightness distribution curve line A of the naked lamp shows that the relative brightness is changed significantly at different positions. It means that the brightness distribution of the backlight module is very poor when the human eyes look at different positions of the backlight module. It is apprehensible that the upper light beams of the lamp are allowed to enter the eyes directly, but the farther light beams can not be diffused to the dark region beside the lamp and the light beams can not be focused into the retinas of the eyes. As a result, almost every direct backlight module can not provide uniform brightness in the absence of an optical film. This backlight phenomenon of extreme non-uniform brightness is usually called as MURA defects. Therefore, a diffuser plate and a diffuser film are essential for the direct backlight module to improve the MURA defects caused by the non-uniform light source or lamp. Referring to the curve line B, this curve line B indicates that the relative brightness becomes very stable and uniform when the above-mentioned two methods are utilized. In other words, the diffuser plate can improve the brightness uniformity of the backlight plate obviously. However, the obtained brightness value may be decreased significantly because of the conservation of energy and the imperfect design. The brightness of the region exactly above the lamp is substantially higher than that of the center region between any two lamps. In particular, with the decrease of lamps in the 32 inches LCD TV, for example, from sixteen lamps to twelve lamps, the brightness and uniformity of the LCD monitor is further reduced, which further reduces the desire of the consumer for buying the LCD monitor. The lamp number of the existing backlight module of the LCD monitor is reduced for the purpose of reducing the production cost, which enlarges the distances among the lamps and makes the MURA defects become more serious. As a result, the diffuser plate and the diffuser film must be formed on the direct backlight module so as to uniform the brightness distribution of the backlight module. In other words, the general direct backlight module utilizes a diffuser plate and two diffuser films to reduce the MURA defects. The semi-sphere (or called as lenticular) refraction structure perhaps improves diffusion effect. But, the aberration usually exists in the semi-sphere microstructure. As a result, the diffusion angle of the light beam is so large that the human eyes can only sense partial brightness because the human eyes have limited filed of view. The addition of diffusion particles and the diffuser plate is unable to enter the retinas. In other words, the thickness of the backlight module must be increased to reduce the MURA defects. However, the increased thickness violates the purpose of forming thinner backlight module. As a result, in order to reduce the number of the lamp and the size and weight of the backlight module, a new design must be introduced into the diffuser plate so as to allow the light beams to enter the eyes and to maintain a certain amount of brightness and uniformity.

### SUMMARY OF THE INVENTION

It is a primary object of the present invention to form an aspheric structure on a plate for improving the brightness. In addition, the present invention discloses a multi-aspheric structure to avoid the non-uniformity of the single aspheric structure.

In order to achieve the above-mentioned object, a diffuser plate having a multi-aspheric structure of the present invention comprises a plate and at least one aspheric microstructure. The plate is made of a transparent polymer and doped with a UV absorbent and several diffusion particles. The aspheric microstructure is formed on at least one surface of the plate and comprises a plurality of aspheric bars having at least one kind of arrangements. The aspheric bars have a curviform profile consisting of at least one curve line. By the use of the aforesaid structure, the present invention can improve the conventional problems and can provide the advantages including high light transmission rate, raised diffusion capability, improved brightness, and uniform light beams.

### BRIEF DESCRIPTION OF THE DRAWINGS

FIG. 1 is a side view showing a conventional diffuser plate doped with diffusion particles.

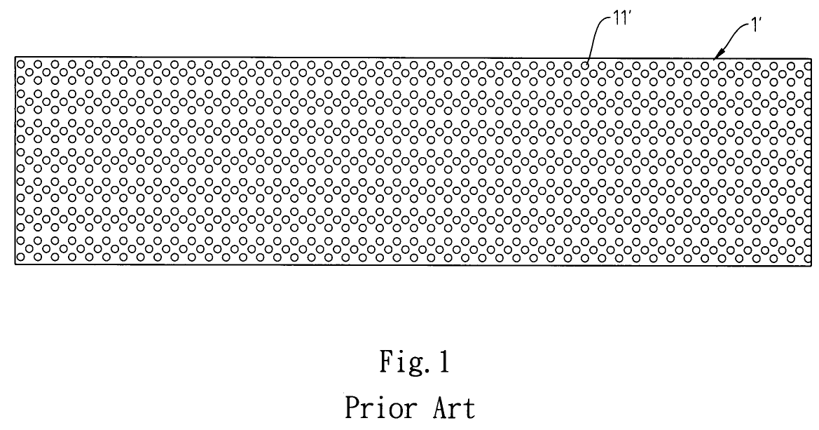

FIG. 2 is an elevational diagram showing a surface structure of the conventional diffuser plate.

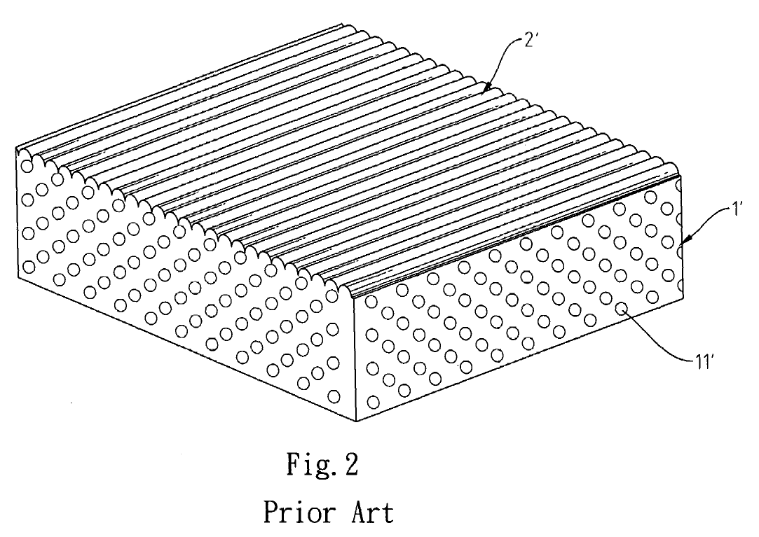

FIG. 3 is a curve diagram showing the relative brightness and uniformity of the prior art.

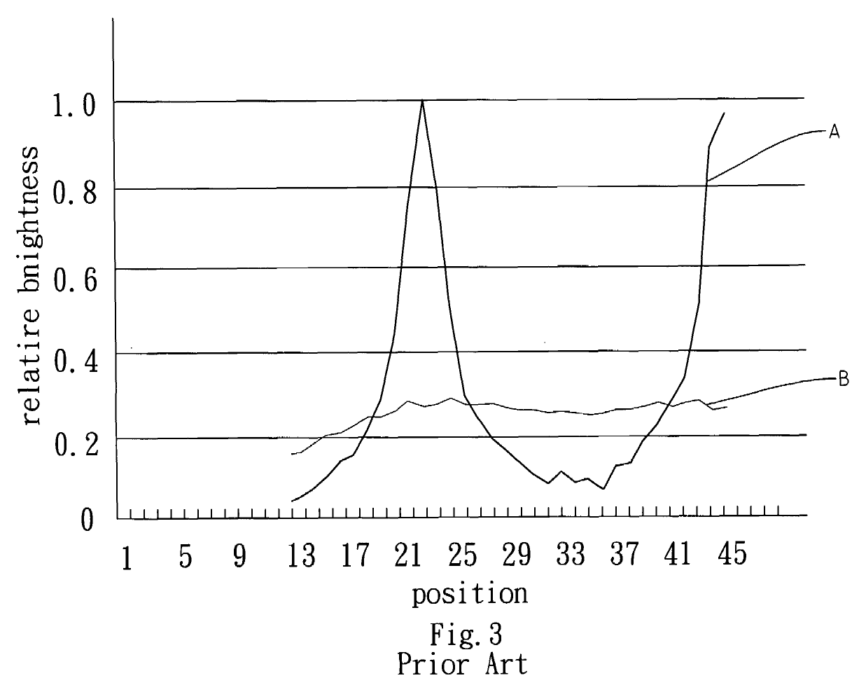

FIG. 4 is an elevational diagram showing the structure of a first preferred embodiment of the present invention.

FIG. 5 is a side view showing the structure of a second preferred embodiment of the present invention.

FIG. 6 is an elevational diagram showing the structure of a third preferred embodiment of the present invention.

FIG. 7 is an elevational diagram showing the structure of a fourth preferred embodiment of the present invention.

FIG. 8 is a side view showing the structure of a fifth preferred embodiment of the present invention.

FIG. 9 is an elevational diagram showing the structure of a sixth preferred embodiment of the present invention.

FIG. 10 is a side view showing the structure of a seventh preferred embodiment of the present invention.

FIG. 11 is a curve diagram showing the comparison of the relative brightness and uniformity between the prior art and the seventh preferred embodiment of the present invention.

FIG. 12 is a curve diagram showing the comparison of the relative brightness and uniformity between the prior art and the seventh preferred embodiment of the present invention.

### DETAILED DESCRIPTION OF THE PREFERRED EMBODIMENT

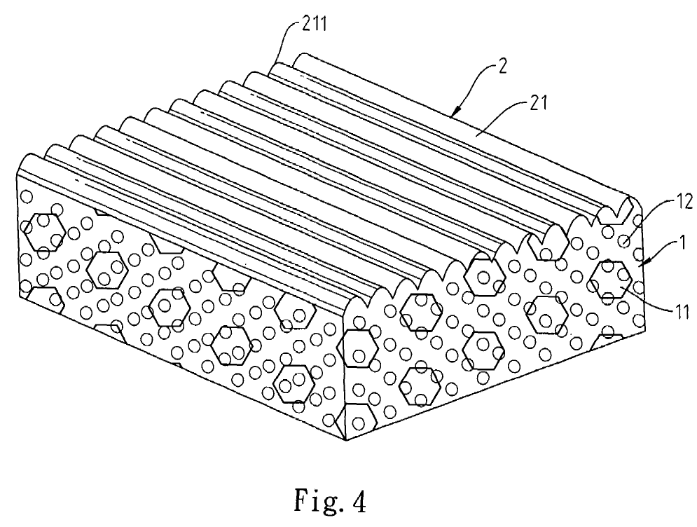

Referring to FIG. 4, a diffuser plate having a multi-aspheric structure in accordance with a first preferred embodiment of the present invention comprises a plate 1 and at least one aspheric microstructure 2. The configuration of the aspheric microstructure 2 is determined by an aspheric equation mentioned in the traditional optics.

The plate 1 is made of a transparent polymer selected from a group consisting of poly(methylmethacrylate) (PMMA), polycarbonate (PC), (methylmethacrylate)styrene (MS) and polystyrene (PS). The plate 1 is integrally formed by an extrusion process for forming a plurality of aspheric microstructures 2 on at least one surface of the plate 1. In addition, the plate 1 has a UV absorbent 11 doped therein to prevent the direct UV light irradiation from causing the plate 1 to generate the phenomena of photoyellowing and cracking. In addition, the plate 1 has several diffusion particles 12 doped therein, wherein the diffusion particles 12 are made of a material selected from a group consisting of poly(methylmethacrylate) (PMMA), polycarbonate (PC), (methylmethacrylate)styrene (MS), polystyrene (PS), silica, silicon, melamine, calcium carbonate, Teflon, TiO₂ and SiO₂. As a result, the phenomenon of optical diffusion occurs when the light passes through the diffusion particles 12.

The aspheric microstructure 2 is formed on at least one surface of aforesaid plate 1. The aspheric microstructure 2 comprises at least one continuously arranged first aspheric bar 21. The curviform profile of the first aspheric bar 21 comprises at least one curve line 211. The curve line 211 is generally an aspheric curve line, a NURB curve line, a SPLINE curve line or a BEZIER curve line. The first aspheric bar 21 and the curve line 211 can be preferably designed in accordance with various light source arrangements of backlight module so that the backlight sources including line sources of CCFLs or point sources of LEDs that pass through the plate 1 and the aspheric microstructure 2 can be transformed into surface sources that have high brightness and uniformity for being applied to the panel. The first aspheric bar 21 can be extruded straightly along the curve line 211. In accordance with requirement or processing limitation, the curve line 211 can be extruded wiggly in such as S shape to form the winding first aspheric bar 21. In the practical processing, this microstructure bar can be carved out by a lathing machine, which has superfine cutting tools and is computer-controlled parameters.

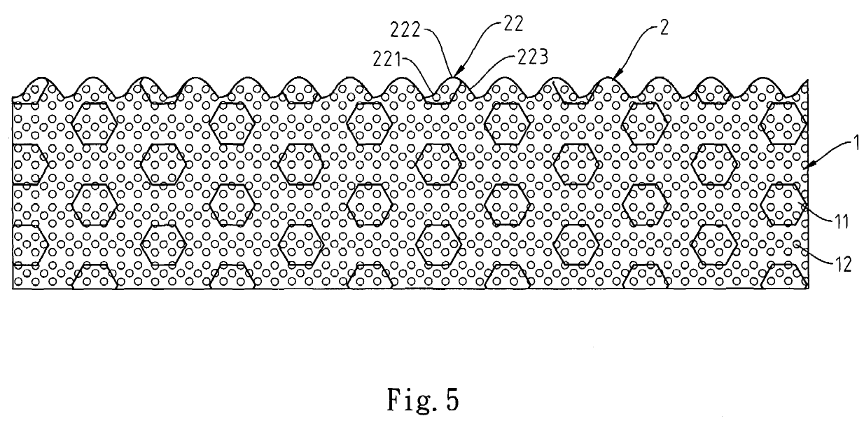

Referring to FIG. 5, a diffuser plate of a second preferred embodiment of the present invention has a configuration similar to that of the first preferred embodiment. The difference is that the aspheric microstructure 2 of the second preferred embodiment has several continuously arranged second aspheric bars 22. Each second aspheric bar 22 comprises a first curve line 221, a circular line 222, and a straight line 223. One end of the first curve line 221 is connected to one end of the circular line 222. The other end of the circular line 222 is connected to one end of the straight line 223. The other end of the straight line 223 is connected to one end of the first curve line 221 of another second aspheric bar 22. In this preferred embodiment, the aspheric profile of the microstructure is constituted by several curve lines. This continuously arranged structure constitutes the aspheric microstructure 2 of the second preferred embodiment.

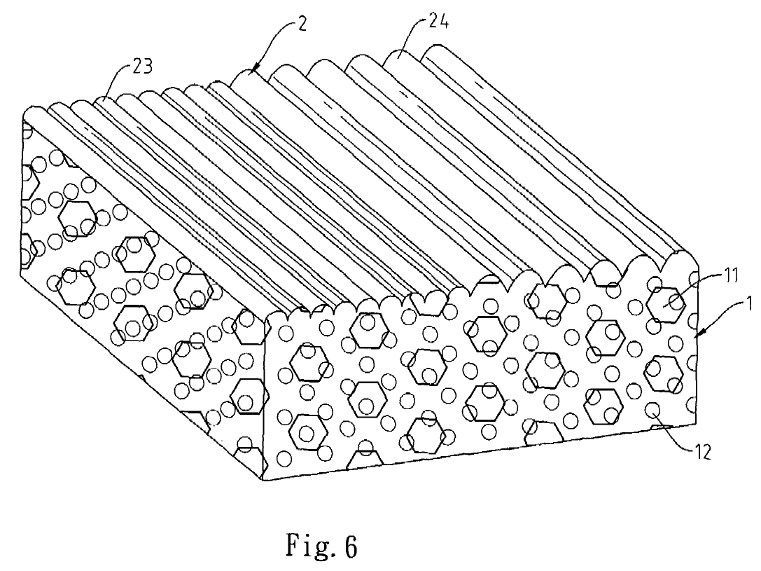

Referring to FIG. 6, a diffuser plate of a third preferred embodiment of the present invention has a configuration similar to that of the first preferred embodiment. The difference is that the aspheric microstructure 2 of the third preferred embodiment has several third aspheric bars 23 and several parallel-arranged fourth aspheric bars 24 that adjacent to the third aspheric bars 23. The third preferred embodiment is characterized by its regional arrangement. In other words, the aspheric structures that have the same shape are arranged in the same small region. The identical bars are distributed in the identical region. As a result, the aspheric microstructure 2 is constituted by various types of bars arranged in various regions.

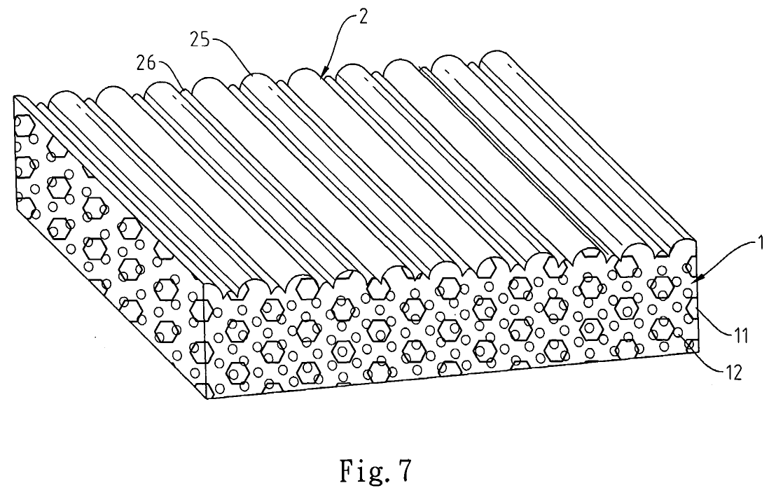

Referring to FIG. 7, a diffuser plate of a fourth preferred embodiment of the present invention has a configuration similar to that of the first preferred embodiment. The regional arrangement of the fourth preferred embodiment is different from that of the third preferred embodiment. In this fourth preferred embodiment, various types of structure are staggered with one other. In this fourth preferred embodiment, the aspheric microstructure 2 comprises several fifth aspheric bars 25 and several sixth aspheric bars 26, wherein every sixth aspheric bar 26 is located between two adjacent sixth aspheric bars 26.

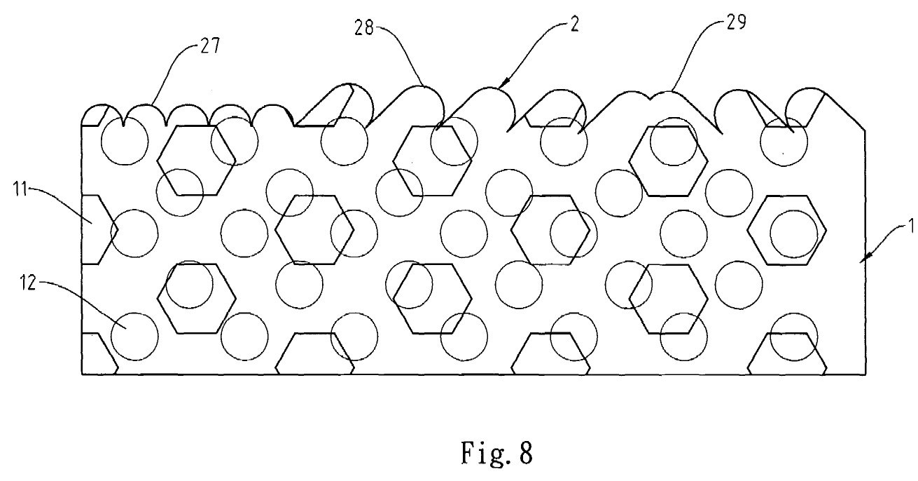

Referring to FIG. 8, a diffuser plate of a fifth preferred embodiment of the present invention has a configuration similar to that of the first preferred embodiment. The difference is that the aspheric microstructure 2 of the fifth preferred embodiment has several parallel-arranged seventh aspheric bars 27, several adjacent-arranged eighth aspheric bars 28, and an adjacent-arranged eighth aspheric bar 29.

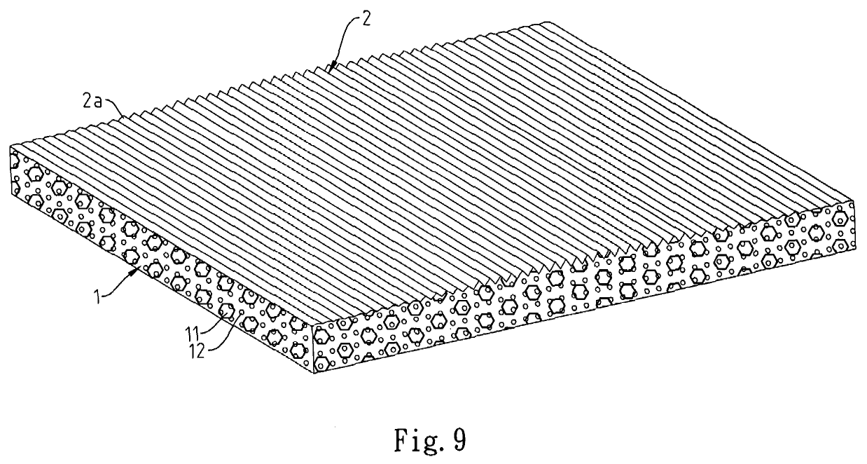

Referring to FIG. 9, a diffuser plate of a sixth preferred embodiment of the present invention has a configuration similar to that of the first preferred embodiment. The difference is that the aspheric microstructure 2 of the sixth preferred embodiment has several parallel-arranged, gradually-changed tenth aspheric bars 2a. The aspheric bars 2a that locate adjacent to each other have different shapes so as to prevent the problem of non-uniform brightness caused by significant difference between adjacent structures. By the use of the gradually-changed aspheric microstructure 2, the brightness and uniformity can be increased effectively.

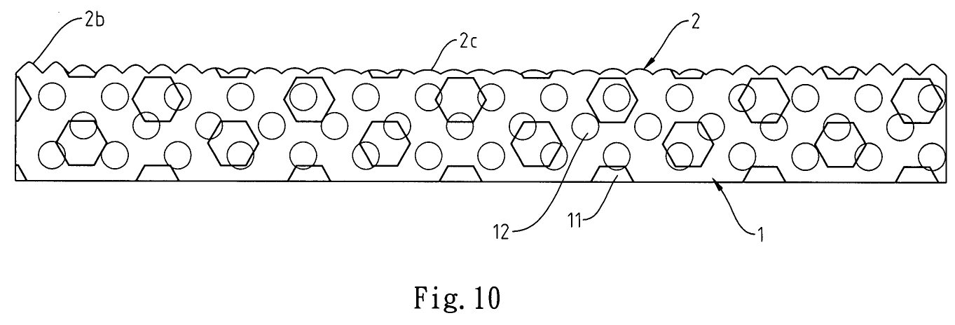

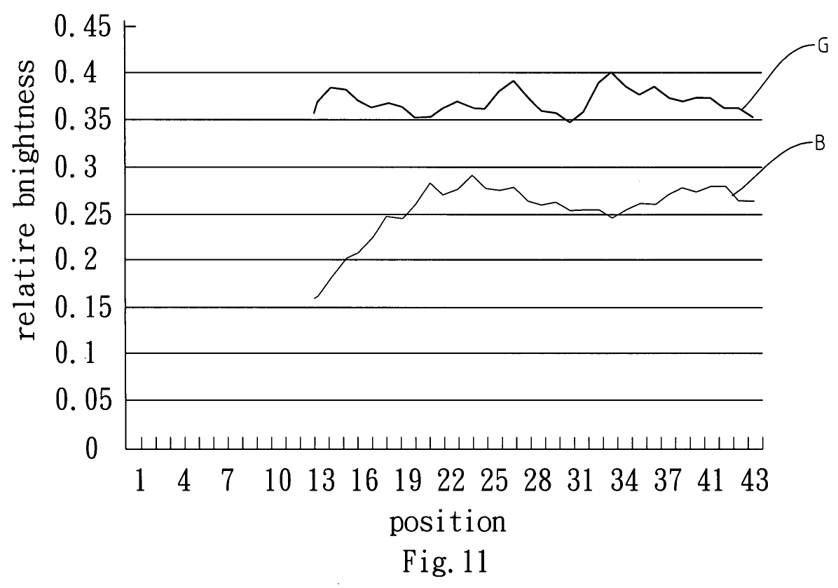

Referring to FIG. 10, a diffuser plate of a seventh preferred embodiment of the present invention has a configuration similar to that of the first preferred embodiment. The difference is that the aspheric microstructure 2 of the seventh preferred embodiment has several parallel-arranged, gradually-changed eleventh aspheric bars 2b and several parallel arranged, gradually-changed twelfth aspheric bars 2c. The eleventh aspheric bars 2b and the twelfth aspheric bars 2c are adjacent to one another and located regularly and continuously. Referring to FIG. 10, the curviform profiles of the aspheric bars 2b and 2c are changed from a smooth shape to a sharp shape. The seventh and sixth preferred embodiments adopt the structures that have gradually changed shapes. However, the aspheric shape of the seventh preferred embodiment is smoother than that of the sixth preferred embodiment. Therefore, the backlight module that utilizes the diffuser plate of the seventh preferred embodiment has smaller average brightness than the backlight module that utilizes the diffuser plate of the sixth preferred embodiment. On the contrary, the backlight module that utilizes the diffuser plate of the seventh preferred embodiment has more uniform visual angle and brightness than the backlight module that utilizes the diffuser plate of the sixth preferred embodiment. Referring to FIG. 11, the horizontal coordinate is the absolute position of the backlight module, and the vertical coordinate is the relative brightness after normalization. This figure shows the brightness distribution curve B of the conventional backlight module that utilizes the spherical reflection structure 2′ of the diffuser plate and the brightness distribution curve G of the diffuser plate of the seventh preferred embodiment. After comparison, the brightness distribution curve B shows that the spherical reflection structure 2′ has low brightness, and the brightness distribution curve G shows that the diffuser plate of the seventh preferred embodiment has high and uniform brightness. Compared with the conventional technology, the seventh preferred embodiment of the present invention increases the brightness by about 38%.

In the above-mentioned seven preferred embodiments, the curviform profiles of the first aspheric bar 21 through the twelfth aspheric bar 2c are constituted by at least one lines. It is apparent that these lines can be constituted by aspheric lines, straight lines, NURB curve lines, SPLINE curve lines, BEZIER curve lines, and sphere lines, which are connected to form a compound asphere surface, such as the compound asphere microstructure of the second preferred embodiment shown in FIG. 5. The aspheric bars of the above-mentioned aspheric microstructure can be constituted by extending the curve lines from the straight lines. In addition, the aspheric microstructure can be constituted by extending the curve lines from the curve lines.

It is worthy of mention that the shape and the distribution density of the aspheric microstructure 2 can be designed in accordance with the aspheric equation, Snell's law and the Fresnel equation. In addition, the distribution result of the brightness can be repeatedly calculated by optical procedure so as to provide the microstructure with optimum shape and distribution in accordance with the relative positions of the light sources and the various sizes of the backlight module. The size of the aspheric microstructure 2 is ranged from several tens micrometers to several hundreds micrometers. In the present invention, the structure width is ranged from about 20 micrometers to 780 micrometers. The practically shape of the diffuser plate may be changed slightly by the processing parameters and affected by the environment. In addition, the microstructure can be simplified to be partially composed of aspheric structures, straight structures or sphere structures according to the simplified route of CNC lathing machine and the reduced processing time. In addition, the microstructure is designed according to the injection molding processing or the extrusion materials so as to reduce the production cost. In the sixth and seventh preferred embodiments, the microstructures are provided with gradually changed shapes. It means that their structures are slightly different from each other so as to obtain optimum brightness and uniformity. But, the sixth and seventh preferred embodiments take longer processing time. As a result, the first through fifth preferred embodiments are disclosed to prevent the brightness value and the uniformity from being decreased significantly. For the purposes of simplifying the processing and procedure, the aspheric structures disclosed in these preferred embodiments are arranged at intervals or at different regions so that one or more aspheric structures that have different shapes can be distributed at the same small region or the aspheric structures that have the same shape can be arranged in the same small region. The aforesaid purposes and efficiency can be also achieved as long as the structures have proper sizes, shapes and arrangements.

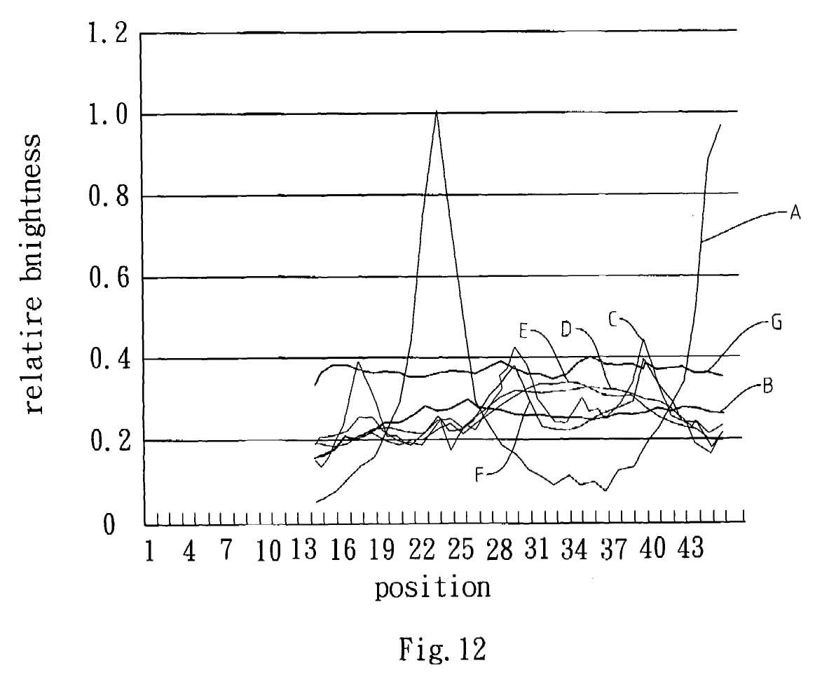

Referring to FIG. 12, a curve diagram is shown. The curve A shows the conventional brightness distribution of the naked lamp without the addition of any diffuser plate. The curve B shows the conventional brightness distribution of the sphere, pillar-shaped diffuser plate. The curves C, D, E, and F show the brightness distribution of other commercial samples of diffuser plate. The curve G shows the brightness distribution of the diffuser plate of the seventh preferred embodiment. After attaching these conventional diffuser plates and the diffuser plate of the seventh preferred embodiment that has the multi-aspheric structure to the backlight modules, a brightness measurement equipment (for example, model Topcon BM7-fast) is utilized to measure the final brightness and uniformity. The measurement result shows that the diffuser plate of the preferred embodiment has better brightness and uniformity than the conventional sphere diffuser plate and the flat-type diffuser plate that is only doped with different diffusion particles.

What the invention claimed is:

1. A diffuser plate having a multi-aspheric structure comprising:
a plate made of a transparent polymer and doped with a plurality of diffusion particles; and
at least one aspheric microstructure formed on at least one surface of said plate, said aspheric microstructure comprising a plurality of aspheric bars having at least one kind of arrangements, said aspheric bars having a curviform profile consisting of at least one curve line.

2. A diffuser plate having a multi-aspheric structure of claim 1, said transparent polymer is made of a transparent polymer selected from a group consisting of poly(methylmethacrylate) (PMMA), polycarbonate (PC), (methylmethacrylate)styrene (MS) and polystyrene (PS).

3. A diffuser plate having a multi-aspheric structure of claim 1, wherein said plate is doped with a UV absorbent.

4. A diffuser plate having a multi-aspheric structure of claim 1, wherein said diffusion particles are made of a material selected from a group consisting of poly(methylmethacrylate) (PMMA), polycarbonate (PC), (methylmethacrylate)styrene (MS), polystyrene (PS), silica, silicon, melamine, calcium carbonate, Teflon, TiO₂ and SiO₂.

5. A diffuser plate having a multi-aspheric structure of claim 1, wherein said curve line is selected from an aspheric line, a straight line, a NURB curve line, a SPLINE curve line, a BEZIER curve line, and a sphere line.

6. A diffuser plate having a multi-aspheric structure of claim 1, wherein said curviform profile of said aspheric bars of said aspheric microstructure is constituted by extending said curve line from a straight line.

7. A diffuser plate having a multi-aspheric structure of claim 1, wherein said curviform profile of said aspheric bars of said aspheric microstructure is constituted by extending said curve line from another curve line.

8. A diffuser plate having a multi-aspheric structure of claim 1, wherein said aspheric bars are staggered with one another.

9. A diffuser plate having a multi-aspheric structure of claim 1, wherein identical bars are distributed in identical region and different bars are distributed in different regions.
